(19) United States
(12) Patent Application Publication
(10) Pub. No.: US 2015/0239165 A1
(43) Pub. Date: Aug. 27, 2015

(54) 3D PRINTER

(71) Applicant: Mao-Sheng Huang, Taichung City (TW)

(72) Inventor: Mao-Sheng Huang, Taichung City (TW)

(21) Appl. No.: 14/192,853

(22) Filed: Feb. 27, 2014

(51) Int. Cl. B29C 47/06

(52) U.S. Cl. CPC B29C 47/06; B33Y 30/00

(57) ABSTRACT

A 3D printer has a base, a driving unit, a material exporting unit and a material tank. A three-dimensional prototype can be generated by the coordination of the material exporting unit and an X-axis rail, Y-axis rail and Z-axis rail of the base. The prototype can be a large item, and the driving unit and electrical control device can be used to control the melting and shooting-out of the plastic particles to increase the prototype's practicality, precision and completeness. Also, the costs of manufacturing the prototype can be significantly reduced.

### FIELD OF THE INVENTION

The present invention relates to a printer, and more particularly to a 3D printer.

### BACKGROUND OF THE INVENTION

A conventional 3D printer can only be used in producing small objects and the output is usually the combination of the stretch of plastic wiring in rolling wheels. The melting temperature is not easy to control that may adversely affect the quality of the prototype, so the number of low quality prototypes may increase to further increase the manufacturing costs. Therefore, there remains a need for a new and improved 3D printer to overcome the problems stated above.

### SUMMARY OF THE INVENTION

The problem of conventional 3D printers is that conventional 3D printer can only be used in producing small objects and the output is usually the combination of the stretch of plastic wiring in rolling wheels. The melting temperature is not easy to control that may adversely affect the quality of the prototype, so the number of low quality prototypes may increase to further increase the manufacturing costs. Therefore, the present invention is provided to solve the problems stated above.

A 3D printer may include a base, a driving unit, a material exporting unit and a material tank. The base has a shaping space that has an X-axis rail on both sides thereof. A Y-axis rail is disposed above the X-axis rails and the Y-axis rail moves linearly along the X-axis rails. A sliding unit is disposed on the Y-axis rail and the sliding unit moves linearly along the Y-axis rail. Also, the sliding unit has a Z-axis rail and a sliding block. The base further includes a computer to provide the commands and parameters to drive the base. The driving unit has a frame located at the sliding block. The frame has a motor connecting with a decelerating mechanism that has a connecting portion at a bottom portion thereof and a positioning hole corresponding to the connecting portion. The material exporting unit has a hollow heating tube a transportation rod and at least three heating pieces. An opening is disposed at an upper portion of the heating tube and a material inlet hole is located at a sidewall thereof. A protruding locking unit is corresponding to the positioning hole of the frame and a printing end is taperedly formed at the bottom portion of the heating tube. The transportation rod can be inserted into the heating tube and an upper portion of the transportation rod is protruding out from the opening to connect with the decelerating mechanism. Three heating pieces are disposed outside the heating tube. An electrical control device is used to control the motor, decelerating mechanism and the temperature of the heating pieces, so the temperature of the three heating pieces can be low, medium and high from top to bottom. The material tank is disposed on one side of the frame and a material inlet tube is at the bottom of the material tank to connect with the material inlet hole.

The present invention is advantageous because the three-dimensional prototype can be generated by the coordination of the material exporting unit and the X-axis rail, Y-axis rail and Z-axis rail of the base. The prototype can be a large item and the driving unit and electrical control device can be used to control the melting and shooting-out of the plastic particles to increase the prototype's practicality, precision and completeness. Also, the costs of manufacturing the prototype can be significantly reduced.

### BRIEF DESCRIPTION OF THE DRAWINGS

FIG. 1 illustrates a three-dimensional view of the present invention.

FIG. 2 illustrates an exploded view of the present invention.

FIG. 3 illustrates a schematic view of the present invention when in use.

FIG. 4 illustrates a schematic view of the material exporting unit in the present invention when in use.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

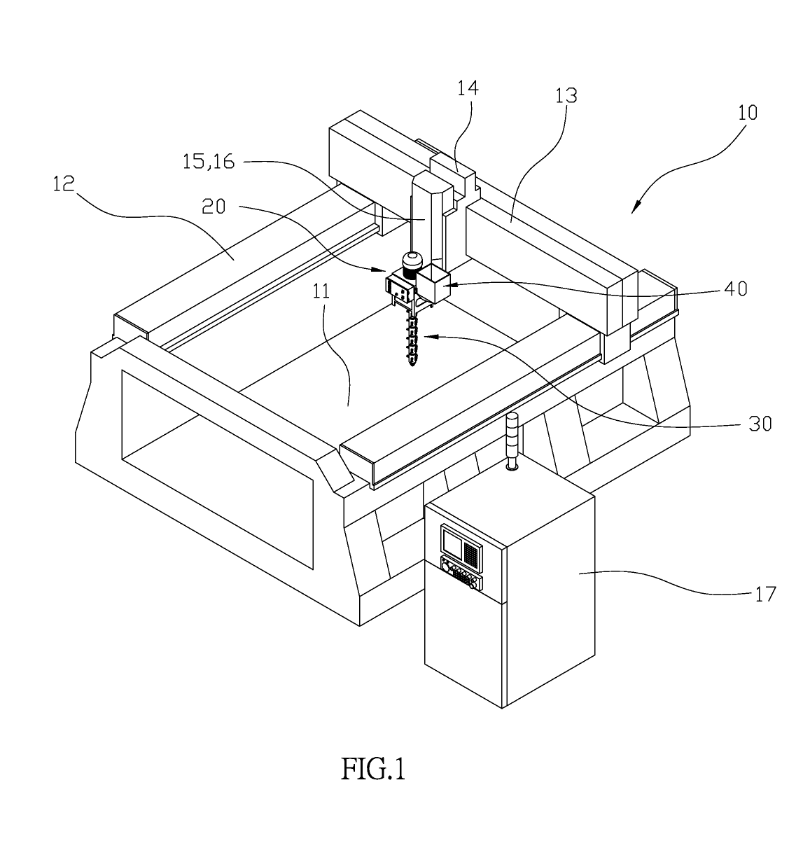

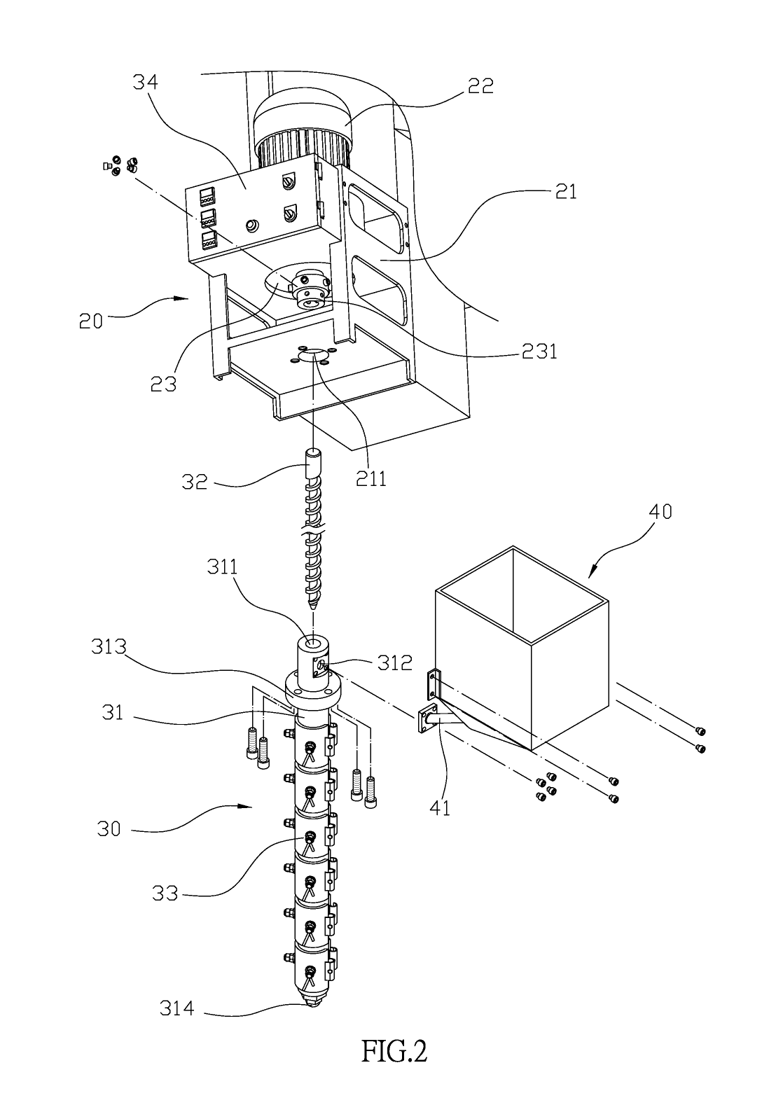

Referring to FIGS. 1 and 2, a 3D printer has a base 10, a driving unit 20, a material exporting unit 30 and a material tank 40. The base 10 has a shaping space 11 that has an X-axis rail 12 on both sides thereof. A Y-axis rail 13 is disposed above the X-axis rails 12 and the Y-axis rail 13 moves linearly along the X-axis rails 12. A sliding unit 14 is disposed on the Y-axis rail 13 and the sliding unit 14 moves linearly along the Y-axis rail 13. Also, the sliding unit 14 has a Z-axis rail 15 and a sliding block 16. The base 10 further includes a computer 17 to provide the commands and parameters to drive the base 10. The driving unit 20 has a frame 21 located at the sliding block 16. The frame 21 has a motor 22 connecting with a decelerating mechanism 23 that has a connecting portion 231 at a bottom portion thereof and a positioning hole 211 disposed at the bottom portion of the frame 21 corresponding to the connecting portion 231. The material exporting unit 30 has a hollow heating tube 31 a transportation rod 32 and at least three heating pieces 33. An opening 311 is disposed at an upper portion of the heating tube 31 and a material inlet hole 312 is located at a sidewall thereof. A protruding locking unit 313 is corresponding to the positioning hole 211 of the frame 21 and a printing end 314 is taperedly formed at the bottom portion of the heating tube 31. The transportation rod 32 can be inserted into the heating tube 31 and an upper portion of the transportation rod 32 is protruding out from the opening 311 to connect with the decelerating mechanism 23. Three heating pieces 33 are disposed outside the heating tube 31.

An electrical control device 34 is used to control the motor 22, decelerating mechanism 23 and the temperature of the heating pieces 33, so the temperature of the three heating pieces can be low, medium and high from top to bottom. The material tank 40 is disposed on one side of the frame 21 and a material inlet tube 41 is at the bottom of the material tank 40 to connect with the material inlet hole 312.

Still referring to FIGS. 1 and 2, the base 10 is secured at the frame 21 through the sliding block 16 and the frame 21 has the motor 22 and decelerating mechanism 23. The upper portion of the heating tube 31 is configured to pass through the positioning hole 211 of the frame 21 and the locking unit 313 is configured to lock through the positioning hole 211. The upper portion of the transportation rod 32 is protruding out from the opening 311 and connected with the connecting portion 231, so the transportation rod 32 can be driven by the decelerating mechanism 23. Furthermore, the material tank 40 is located on one side of the frame 21 and the material inlet tube 41 is configured to connect with the material inlet hole 312, so that the driving unit 20, material exporting unit 30 and the material tank 40 can be driven by the frame 21 and the sliding block 16 of the base 10, and the X-axis rail 12, Y-axis rail 13 and Z-axis rail 15 are used to provide routes for 3D printing.

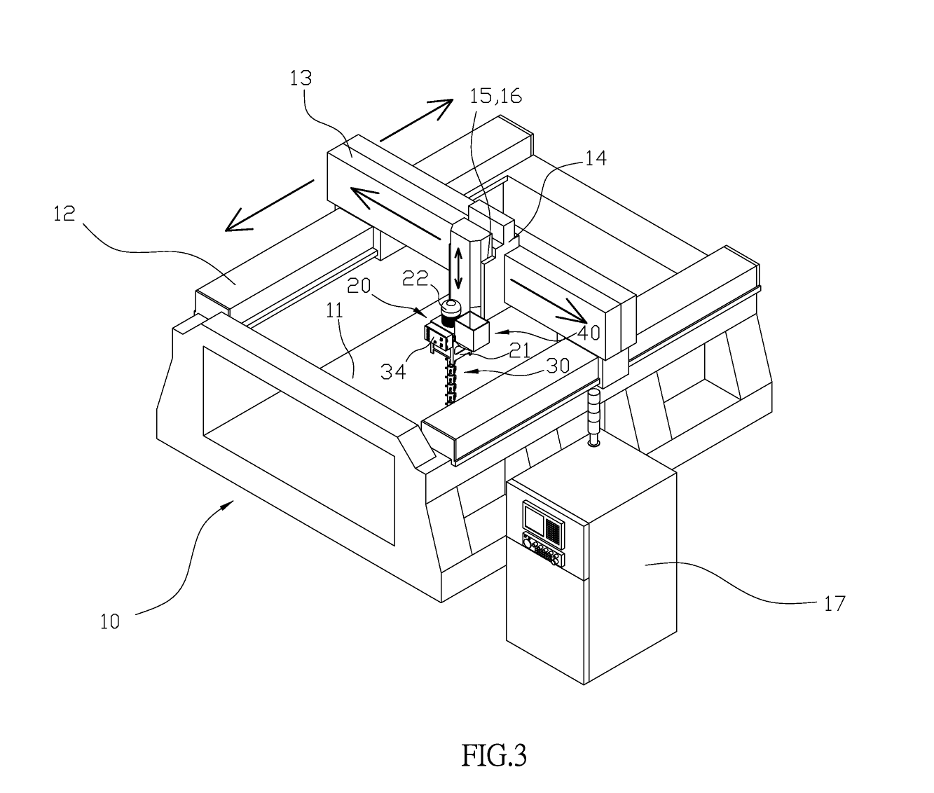

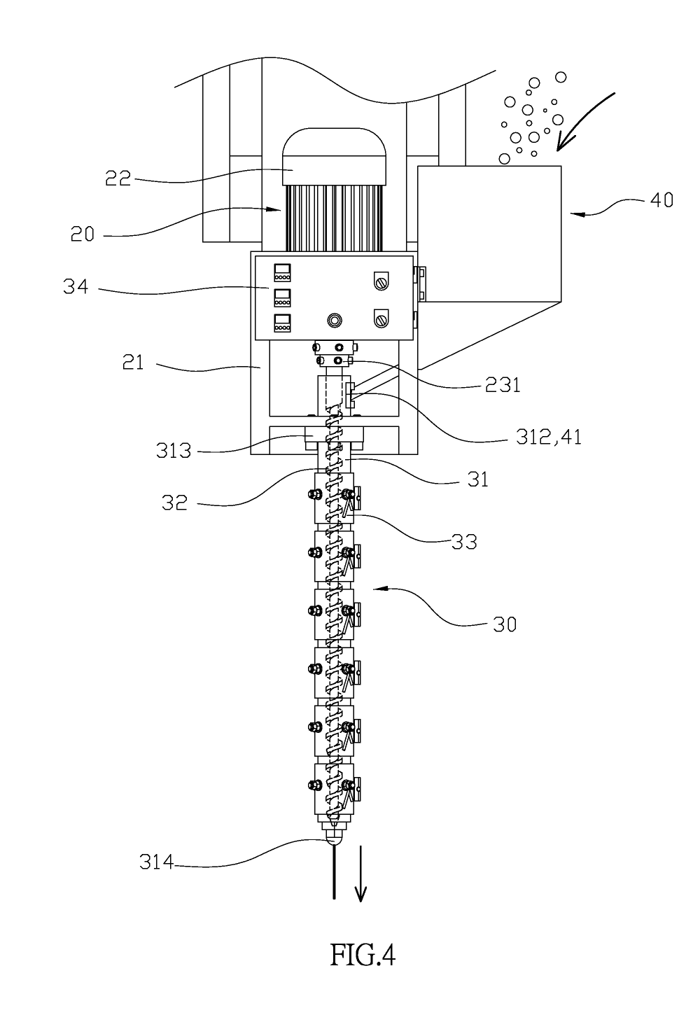

Referring to FIGS. 3 and 4, when the 3D printer is in use, the X-axis rail 12, Y-axis rail 13 and Z-axis rail 15 are configured to provide routes for 3D printing and the material exporting unit 30 is used to dispose plastic particles that may be shot out for printing in the material tank 40. The plastic particles are transported from the material inlet tube 41 to the material inlet hole 312 and the heating tube 31. The motor 22 and decelerating mechanism 23 are used to drive the transportation rod 32, so the plastic particles can gradually be moved down in the heating tube 31. Three heating pieces 33 are disposed outside the heating tube 31 and the temperature thereof can be controlled by the electrical control device 34, so the plastic particles can be melt to a deformable liquid with plasticity and shot out from the printing end 314 of the bottom portion of the heating tube 31. With the commands and parameters in the computer 17, the movement of the base 10, sliding unit 14 and sliding block 16 can be controlled, so the deformable liquid can be shot out in the shaping space 11 of the base 10 to form a three-dimensional prototype.

According to the embodiments described above, the present invention is advantageous because the three-dimensional prototype can be generated by the coordination of the material exporting unit 30 and the X-axis rail 12, Y-axis rail 13 and Z-axis rail 15 of the base 10. The prototype can be a large item and the driving unit 20 and electrical control device 34 can be used to control the melting and shooting-out of the plastic particles to increase the prototype's practicality, precision and completeness. Also, the costs of manufacturing the prototype can be significantly reduced.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A 3D printer comprising:
a base having a shaping space that has an X-axis rail on both sides thereof, a Y-axis rail disposed above the X-axis rails and the Y-axis rail moving linearly along the X-axis rails, a sliding unit disposed on the Y-axis rail and the sliding unit moving linearly along the Y-axis rail, the sliding unit having a Z-axis rail and a sliding block;
a driving unit having a frame located at the sliding block and the frame having a motor connecting with a decelerating mechanism that has a connecting portion at a bottom portion thereof, a positioning hole that is disposed at a bottom portion of the frame corresponding to the connecting portion;
a material exporting unit having a hollow heating tube a transportation rod and at least three heating pieces, wherein an opening is disposed at an upper portion of the heating tube and a material inlet hole is located at a sidewall thereof, and a protruding locking unit is corresponding to the positioning hole of the frame and a printing end is taperedly formed at the bottom portion of the heating tube, wherein the transportation rod is inserted into the heating tube and an upper portion of the transportation rod is protruding out from the opening to connect with the decelerating mechanism, and three heating pieces are disposed outside the heating tube; and
a material tank disposed on one side of the frame and a material inlet tube at a bottom portion of the material tank to connect with the material inlet hole.

2. The 3D printer of claim 1, wherein an electrical control device is used to control the motor, decelerating mechanism and temperature of the heating pieces.

3. The 3D printer of claim 2, wherein the temperature of the three heating pieces is adjustable to be low, medium and high from top to bottom.

4. The 3D printer of claim 1, wherein the base has a computer to provide commands and parameters to control the base.

5. A 3D printer comprising:
a driving unit having a frame located at the sliding block and the frame having a motor connecting with a decelerating mechanism that has a connecting portion at a bottom portion thereof, a positioning hole that is disposed at a bottom portion of the frame corresponding to the connecting portion;
a material exporting unit having a hollow heating tube a transportation rod and at least three heating pieces, wherein an opening is disposed at an upper portion of the heating tube and a material inlet hole is located at a sidewall thereof, and a protruding locking unit is corresponding to the positioning hole of the frame and a printing end is taperedly formed at the bottom portion of the heating tube, wherein the transportation rod is inserted into the heating tube and an upper portion of the transportation rod is protruding out from the opening to connect with the decelerating mechanism, and three heating pieces are disposed outside the heating tube; and
a material tank disposed on one side of the frame and a material inlet tube at a bottom portion of the material tank to connect with the material inlet hole.

6. The 3D printer of claim 5, wherein an electrical control device is used to control the motor, decelerating mechanism and temperature of the heating pieces.

7. The 3D printer of claim 6, wherein the temperature of the three heating pieces is adjustable to be low, medium and high from top to bottom.

8. The 3D printer of claim 5, further comprising a base having a shaping space that has an X-axis rail on both sides thereof, a Y-axis rail disposed above the X-axis rails and the Y-axis rail moving linearly along the X-axis rails, a sliding unit disposed on the Y-axis rail and the sliding unit moving linearly along the Y-axis rail, the sliding unit having a Z-axis rail and a sliding block.

9. The 3D printer of claim 8, wherein the base has a computer to provide commands and parameters to control the base.
